(19) United States
(12) Patent Application Publication
(10) Pub. No.: US 2004/0124129 A1
(43) Pub. Date: Jul. 1, 2004

(54) Filter element assembly and parts therefor

(75) Inventor: Walter A. Booth, East Hanover, NJ (US)

Correspondence Address: SELITTO, BEHR & KIM, 203 MAIN STREET, METUCHEN, NJ, 08840, US

(73) Assignee: H-Tech, Inc.

(21) Appl. No.: 10/335,582

(22) Filed: Dec. 31, 2002

(51) Int. Cl. B01D 29/54

(52) U.S. Cl. 210/232; 210/342; 210/450

(57) ABSTRACT

A filter element assembly includes an outer filter member and an inner filter member. The filter assembly is also provided with a support cap having an outer ring, which is connected to the outer filter member, and an inner ring, which is connected to the inner filter member. The support cap also includes a plurality of connecting members connecting the outer ring to the inner ring, which is positioned substantially within the outer ring. Each of the connecting members is sized and shaped so as to allow the outer ring and the inner ring to move relative to each other.

### FIELD OF THE INVENTION

The present invention relates to filter element assemblies and, more particularly, to a filter element assembly adapted for use in filtering a fluid stream.

### BACKGROUND OF THE INVENTION

A conventional filter bag assembly includes a filter bag and a perforated metal basket for supporting the filter bag against the pressure of fluid flow. The filter bag is typically provided with a support cap with openings that permit the passage of fluids to be filtered by the filter bag. In operation, fluid enters the filter bag through the openings in the support cap and exits through the porous filtering walls of the filter bag. The filtered-out particulate matter remains in the filter bag.

Conventional filter bag assemblies, however, have various shortcomings and disadvantages. For example, the support cap of the conventional filter bag is not adapted to adjust itself when the filter bag is mounted in an associated metal basket or filter vessel. Consequently, the support cap can be improperly positioned relative to the metal basket and/or the filter vessel and can thereby hinder proper sealing between the support cap and the filter vessel and/or between the support cap and the metal basket. Moreover, the filtered-out particulate matter may undesirably aggregate along the filtering walls of the filter bag. As a result of such aggregation, the flow rate of the filtration process may rapidly decrease, thereby reducing the efficiency and the operating life of the conventional filter bag assembly.

### SUMMARY OF THE INVENTION

The present invention overcomes the disadvantages and shortcomings discussed above by providing a filter assembly having an outer filter member and an inner filter member. The filter assembly also includes a device (e.g., a support cap) adapted for assembling the filter members with one another. More particularly, the device includes an outer ring, which is sized and shaped so as to be connected to the outer filter member, and an inner ring which is sized and shaped so as to be connected to the inner filter member. The device also includes a plurality of connecting members connecting the outer ring to the inner ring, which is positioned substantially within the outer ring. Each of the connecting members is sized and shaped so as to allow the outer ring and the inner ring to move relative to each other. In this manner, the outer and inner rings can be positioned in proper orientation relative to an associated filter basket or filter vessel.

### BRIEF DESCRIPTION OF THE DRAWINGS

For a more complete understanding of the present invention, reference is made to the following detailed description of an exemplary embodiment of the present invention considered in conjunction with the accompanying drawings, in which:

FIG. 1 is a perspective view of a filter bag assembly constructed in accordance with the best known mode of practicing the present invention;

FIG. 2 is a cross-sectional view, taken along section line II-II and looking in the direction of the arrows, of the filter bag assembly shown in FIG. 1, illustrating an associated filter vessel in phantom;

FIG. 3 is an exploded perspective view, partially shown in section, of the filter bag assembly shown in FIG. 1;

FIG. 3A is an exploded perspective view of a support cap and a sealing collar of the filter bag assembly shown in FIGS. 1-3;

FIG. 3B is a perspective view of a ligature of the support cap shown in FIG. 3A;

FIG. 4 is a perspective view, partially shown in section, of an end cap of the filter bag assembly shown in FIGS. 1-3;

FIG. 5 is an enlarged cross-sectional view of an upper portion of the filter bag assembly shown in FIG. 2; and

FIG. 6 is a cross-sectional view, taken along section line VI-VI and looking in the direction of the arrows, of the filter bag assembly shown in FIG. 1.

### DETAILED DESCRIPTION OF THE EXEMPLARY EMBODIMENT

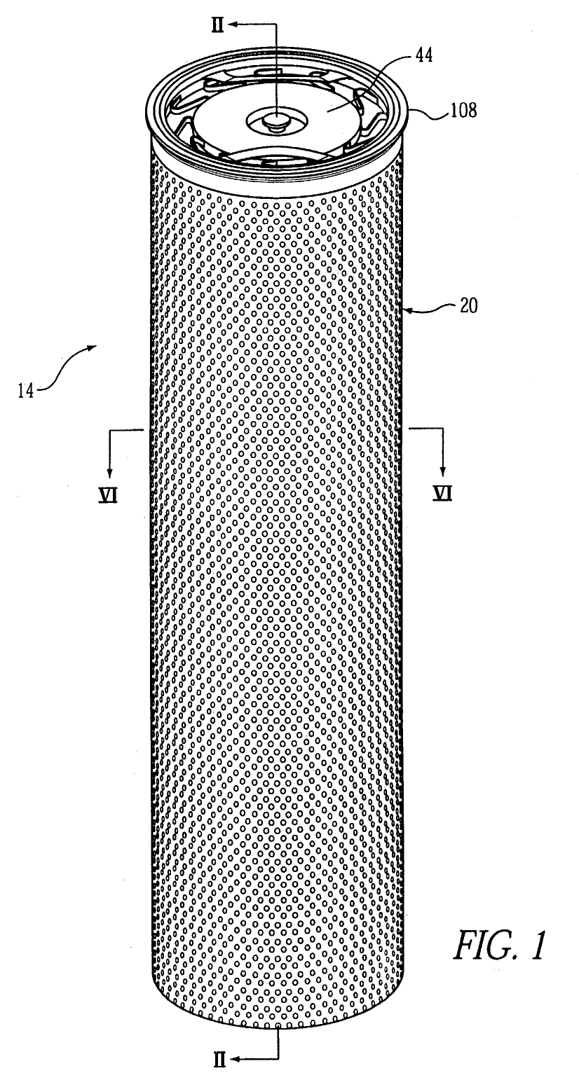

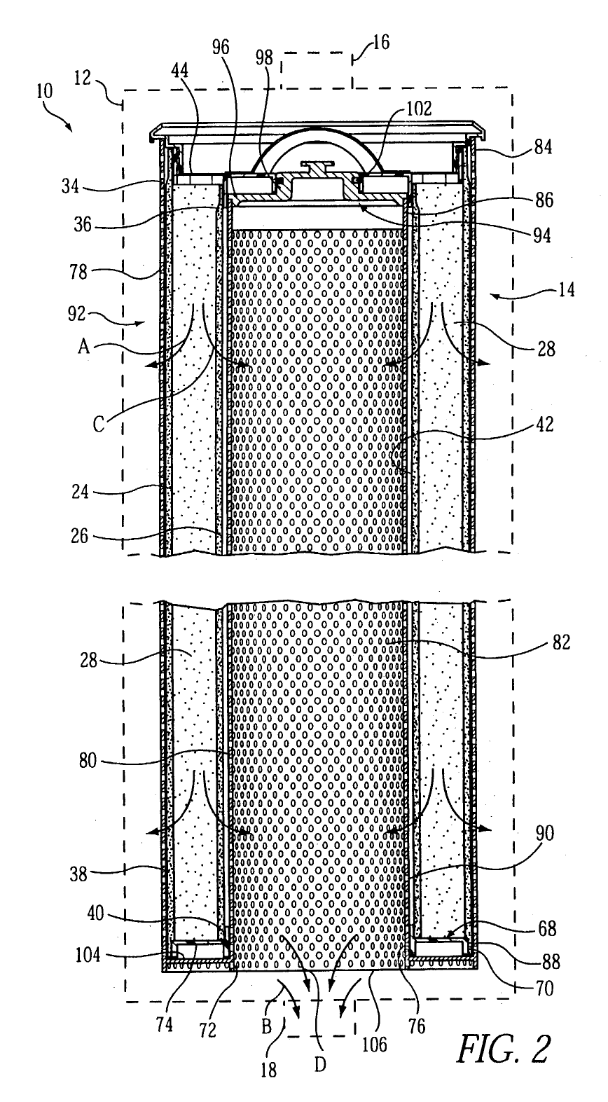

FIGS. 1 and 2 illustrate a filter system or assembly 10 constructed in accordance with an exemplary embodiment of the present invention. The filter system 10 includes a filter vessel 12 (shown in phantom in FIG. 2) and a filter bag assembly (or filter element assembly) 14 sized and shaped so as to be positioned in the filter vessel 12. The filter bag assembly 14 is adapted for removing particulate matters (e.g., dirt, oil, sludge, etc.) from a fluid stream, such as a liquid or gas stream, passing through the filter bag assembly 14. The filter vessel 12, which has a construction and operation similar to the construction and operation of a conventional filter vessel, includes an inlet 16 for receiving fluid to be filtered and an outlet 18 for discharging filtered fluid from the filter vessel 12. An example of a suitable filter vessel is disclosed in U.S. Pat. No. 5,075,004, the disclosures of which are incorporated herein by reference.

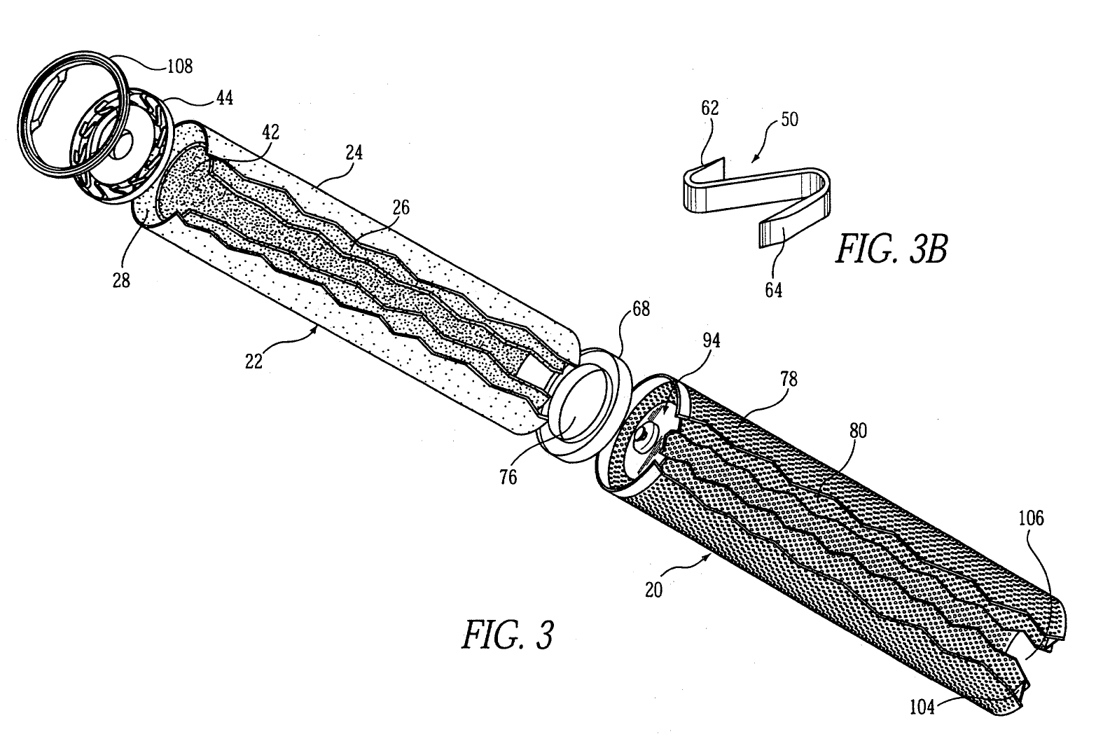

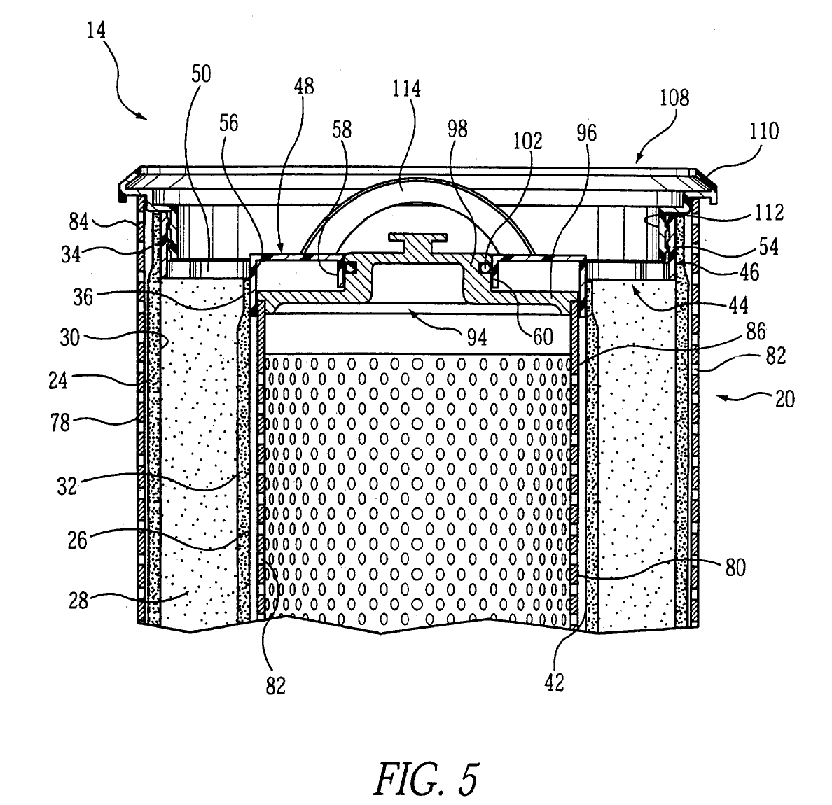

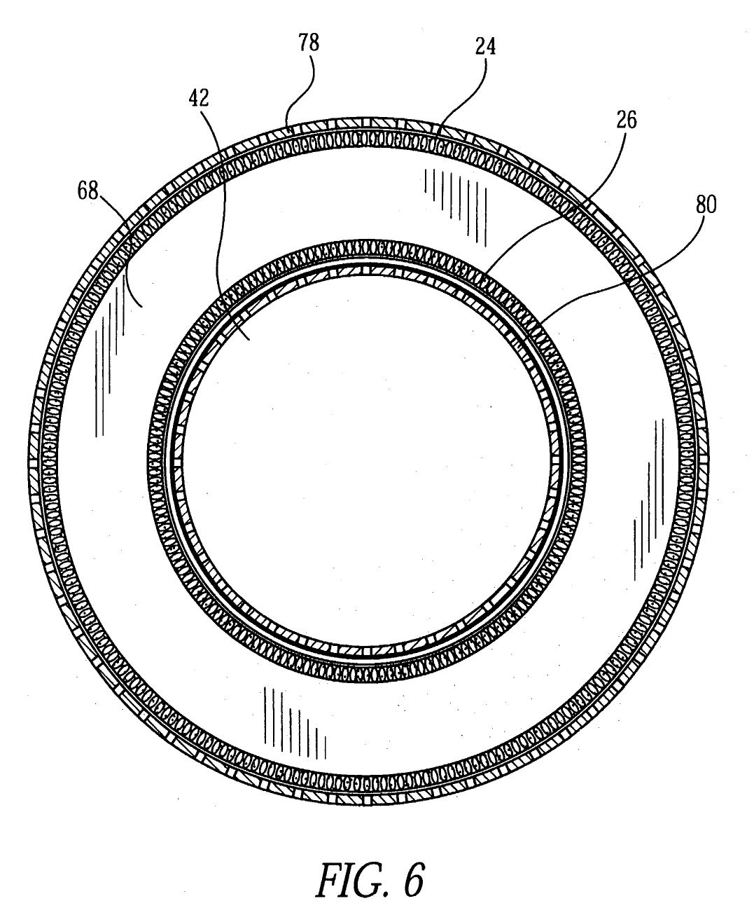

Referring to FIGS. 2 and 3, the filter bag assembly 14 is equipped with a restrainer basket 20 and a filter element 22 sized and shaped so as to be received in the restrainer basket 20. The filter element 22 includes a cylindrical, elongated outer filter bag (or filter member) 24 and a cylindrical, elongated inner filter bag (or filter member) 26 which is arranged substantially concentrically relative to the outer bag 24. In other words, the outer bag 24 has a diameter which is greater than the diameter of the inner bag 26. As a result of their generally coaxial arrangement, the outer bag 24 and the inner bag 26 cooperate to form an annular space 28 therebetween. The outer and inner bags 24, 26 have filtering walls 30, 32, respectively (see FIG. 5). Each of the filtering walls 30, 32 of the outer and inner bags 24, 26, respectively, is made from suitable filtering media (e.g., polypropylene, polyester, etc.) which permit passage of fluid therethrough while inhibiting passage of undesired particulate matters contained in the fluid. As a result, particulate matters contained in the fluid collect on the filtering walls 30, 32 of the outer and inner bags 24, 26, respectively. The outer and inner bags 24, 26 also have upper ends 34, 36, respectively, and lower ends 38, 40, respectively. An interior hollow 42 is formed in the inner bag 26, extending along the entire length of the filtering wall 32.

Now referring to FIGS. 1, 3 and 3A, the filter bag assembly 14 is also equipped with a support cap 44 for assembling or securing the outer and inner bags 24, 26 to one another. More particularly, the support cap 44 includes an outer ring 46, an inner ring 48 and a plurality of ligatures (i.e., connectors) 50 which connect the outer ring 46 to the inner ring 48. The ligatures 50 are spaced from each other so as to form an opening 52 between each adjacent pair of the ligatures 50. The outer ring 46 has a cylindrically-shaped external wall 54 attached to the upper end 34 of the outer bag 24 (see FIG. 5) by any suitable attaching means, while the inner ring 48 has a cylindrically-shaped external wall 56 attached to the upper end 36 of the inner bag 26 (see FIG. 5) by any suitable attaching means. Suitable attaching means includes ultrasonic welding, conventional adhesives and glues, laser bonding, “snap fit” or any other mechanical attachment known in the art. The inner ring 48 also includes a cylindrically-shaped internal wall 58, which is generally concentric relative to the external wall 56. A circular opening or hole 60 is formed substantially at the center of the inner ring 48 and is defined by the internal wall 58. The opening 60 may be utilized for mounting additional filtering components, such as a filter cartridge (not shown), in the interior hollow 42 of the inner bag 26. An example of a suitable filter cartridge is disclosed in U.S. Pat. No. 6,007,718, the disclosures of which are incorporated herein by reference.

With reference to FIGS. 3A and 3B, each of the ligatures 50 is flexible and has an outer end 62, which is connected to the outer ring 46, an inner end 64, which is connected to the inner ring 48, and a connecting member 66, which extends between the outer end 62 and the inner end 64. Each of the connecting members 66 is slanted relative to an associated radial axis of the support cap 44 so as to provide the ligatures 50 with a generally S-shape. Due to their shape and/or flexibility, the ligatures 50 can expand and contract in various directions (e.g., in a radial direction and/or a direction generally parallel to the longitudinal axis of the filter element 22) so as to allow the outer ring 46 and the inner ring 48 to move relative to each other in such directions for purposes to be discussed hereinafter. Although the ligatures 50 have an S-shape, they can be provided with other shapes. In addition, while the ligatures 50 are preferably formed integrally with the outer and inner rings 46, 48 as a single unit, they can be formed as discrete members.

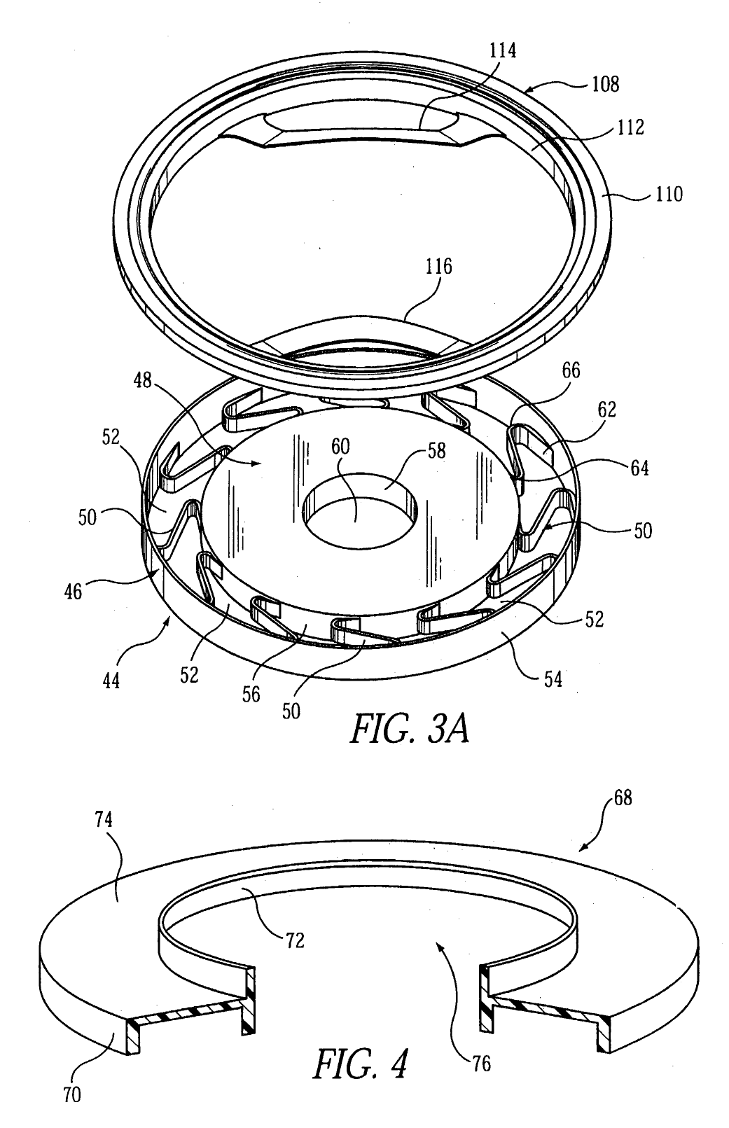

Now referring to FIGS. 2, 3 and 4, the filter bag assembly 14 includes an end cap 68 having an outer peripheral wall 70, which is attached to the lower end 38 of the outer bag 24 in a conventional manner, and an inner peripheral wall 72, which is attached to the lower end 40 of the inner bag 26 in a conventional manner. A solid barrier 74 extends between the outer and inner peripheral walls 70, 72 so as to close off the bottom end of the annular space 28 of the filter element 22. The end cap 68 also has a center opening 76 communicating with the interior hollow 42 of the inner bag 26.

Referring to FIGS. 2, 3, and 5, the restrainer basket 20 includes a cylindrical, elongated outer member 78 and a cylindrical, elongated inner member 80 which is positioned substantially concentrically relative to the outer member 78. In other words, the outer member 78 has a diameter which is greater than the diameter of the inner member 80. Each of the outer and inner members 78, 80 of the restrainer basket 20 is perforated with a plurality of holes 82 for permitting passage of fluid therethrough. The outer and inner members 78, 80 also have upper ends 84, 86, respectively, and lower ends 88, 90, respectively. The outer and inner members 78, 80 of the restrainer basket 20 can be made from any suitable conventional materials, such as stainless steel.

The restrainer basket 20 also includes a crown member 94 (see FIGS. 2, 3 and 5) attached to the inner member 80. More particularly, the crown member 94 is provided with a flange member 96, which is fixedly or removably attached to the upper end 86 of the inner member 80, and a protrusion 98, which extends upwardly from the flange member 96. The protrusion 98 is sized and shaped so as to be received in the opening 60 of the support cap 44 for closing off the opening 60. A sealing member 102, such as an O-ring, is placed between the internal wall 58 of the inner ring 48 and the protrusion 98 of the crown member 94 so as to form a substantially fluid-tight seal between the inner ring 48 and the crown member 94. Alternatively, the inner ring 48 may include other conventional sealing mechanisms. An annular end plate 104 (see FIGS. 2 and 3) is also provided at the lower end of the restrainer basket 20. The end plate 104 is mounted to the lower ends 88, 90 of the outer and inner members 78, 80, respectively, of the restrainer basket 20. An opening 106 (see FIG. 3) is formed in the lower end 90 of the inner member 80.

Referring primarily to FIGS. 3, 3A and 5, the filter bag assembly 14 includes a sealing collar 108 which has a construction and operation similar to the construction and operation of the sealing collar disclosed in U.S. Pat. No. 5,075,004. The sealing collar 108 is mounted to the outer ring 46 of the support cap 44 and includes a lip portion 110 and a flange portion 112 depending therefrom. The flange portion 112 is sized and shaped so as to be positioned within, and attached to, the outer ring 46 of the support cap 44, while the lip portion 110 is sized and shaped so as to be supported on the outer member 78 of the restrainer basket 20. The sealing collar 108 is adapted to provide a seal between the outer ring 46 and the filter vessel 12 in the manner described in U.S. Pat. No. 5,075,004. The sealing collar 108 can be provided with a pair of handles 114, 116 integrally attached thereto for use in mounting and removing the filter element 22 from the filter vessel 12. The sealing collar 108 can be made from any suitable materials such as a plastic material (e.g., polypropylene or polyester).

When the filter element 22 is assembled with the restrainer basket 20, the outer and inner bags 24, 26 of the filter element 22 are removably positioned in an annular space formed between the outer and inner members 78, 80 of the restrainer basket 20. More particularly, the outer bag 24 is positioned within the outer member 78 of the restrainer basket 20 (see FIG. 2), while the inner bag 26 is positioned radially outwardly from the inner member 80 (see FIG. 2). The end plate 104 of the restrainer basket 20 supports the end cap 68 and hence the filter element 22. When the assembly of the restrainer basket 20 and the filter element 22 is mounted in the filter vessel 12, a space 92 (see FIG. 2) is formed between the outer member 78 of the restrainer basket 20 and the filter vessel 12.

In operation, fluid to be filtered is delivered into the filter vessel 12 through the inlet 16. The fluid then flows through the openings 52 of the support cap 44 into the annular space 28 formed between the outer and inner bags 24, 26. Thereafter, some of the fluid flows from the annular space 28 of the filter element 22 into the space 92 of the filter vessel 12 through the filtering wall 30 of the outer bag 24 and the outer member 78 of the restrainer basket 20 (as indicated by arrow A in FIG. 2) and is then discharged from the filter vessel 12 through the outlet 18 (as indicated by arrow B in FIG. 2). The remaining portion of the fluid flows from the annular space 28 of the filter element 22 into the interior hollow 42 of the inner bag 26 through the filtering wall 32 of the inner bag 26 and the inner member 80 of the restrainer basket 20 (as indicated by arrow C in FIG. 2) and is then discharged from the filter vessel 12 through the outlet 18 (as indicated by arrow D in FIG. 2). The restrainer basket 20 functions to support the outer and inner bags 24, 26, which are pressed against the outer and inner member 78, 80, respectively, of the restrainer basket 20 due to the pressure of fluid passing therethrough.

It should be appreciated that the present invention provides numerous advantages over the prior art discussed above. For instance, due to their flexibility and/or shape, the ligatures 50 permit movement of the outer ring 46 relative to the inner ring 48 so as to provide an enhanced seal between the filter element 22 and the restrainer basket 20 and/or the filter vessel 12. More particularly, although the restrainer basket 20 is manufactured in specific dimensions with a given tolerance, the outer member 78 and/or the inner member 80 of the support cap 44 may be misaligned (e.g., positioned off-center) due to, for instance, manufacturing tolerances, and may hence cause concentricity variations (i.e., not having a common center) between the restrainer basket 20 and the filter element 22. Such concentricity variations may cause improper sealing between the filter element 22 and the restrainer basket 20 (i.e., may allow fluid entering the filter vessel 12 to by-pass the filtering walls 30, 32 of the outer and inner bags 24, 26, respectively). Because the outer ring 46 and the inner ring 48 are adapted to move relative to each other, they can be positioned in proper orientation with respect to the restrainer basket 20 and/or the filter vessel 12 (i.e., they are self-adjusting). The outer bag 24 and the inner bag 26 of the filter element 22 can thus be positioned in proper orientation with respect to the outer member 78 and inner member 80, respectively, of the restrainer basket 20, thereby compensating for the concentricity variations discussed above.

Without limiting the structure and function of the ligatures 50 of the support cap 44, it is believed that the shapes of the ligatures 50 and/or the openings 52 of the support cap 44 cooperate to induce a turbulent (e.g., cyclonic) fluid flow through the filter bag assembly 14. As the fluid flows in the filter element 22 in a cyclonic fashion, the particulate matter contained therein tends to deposit more tangentially (i.e., in a layered fashion) onto the filtering walls 30, 32 of the outer and inner bags 24, 26, respectively, compared to the prior art discussed above. As a result, the particulate matter tends to be distributed substantially evenly along the filtering walls 30, 32 of the outer and inner bags 24, 26, respectively (i.e., localized accumulation of particulate matter is minimized). Consequently, the efficiency of the filtration process is enhanced (e.g., a high flow rate may be maintained throughout the filtration process), and the life expectancy of the outer and inner bags 24, 26 is increased.

It should be noted that the present invention can have numerous variations and modifications. For instance, the vertical orientation of the filter bag assembly 14 illustrated and described herein is merely exemplary, and the filter bag assembly 14 can hence have other orientations (e.g., a horizontal orientation, an up-side-down orientation, etc.). The outer ring 46 can also be provided with a sealing component, such as O-rings, to provide a seal between the outer ring 46 and the filter vessel 12, thereby eliminating the need for the sealing collar 108. In addition, the support cap 44 and the sealing collar 108 may be formed integrally as a single unit. Also, the outer bag 24 and the inner bag 26 may have a common closed end (not shown), thereby eliminating the need for the end cap 68. The outer and inner bags 24, 26 can be multi-layered. Further, the support cap 44 may have a molded construction, while the end plate 104 of the restrainer basket 20 can be solid or perforated. Although two handles 114, 116 are shown for the sealing collar 108, the number can vary. Moreover, when additional filtering components (e.g., a filter cartridge) are to be mounted in the filter bag assembly 14, the crown member 94 of the restrainer basket 20 can be eliminated.

It will be understood that the embodiment described herein is merely exemplary and that a person skilled in the art may make many variations and modifications without departing from the spirit and scope of the invention. All such variations and modifications, including those discussed above, are intended to be included within the scope of the invention as defined by the appended claims.

I claim:

1. A device for assembling filter members with one another, comprising an outer ring sized and shaped so as to be connected to an outer filter member; an inner ring positioned substantially within said outer ring and sized and shaped so as to be connected to an inner filter member; and a plurality of connectors connecting said outer ring to said inner ring, each of said connectors being sized and shaped so as to allow said outer ring and said inner ring to move relative to each other.

2. The device of claim 1, wherein each of said connectors is flexible so as to facilitate movement of said outer ring relative to said inner ring.

3. The device of claim 2, wherein each of said connectors is slanted with respect to an associated radial axis of said outer ring.

4. The device of claim 3, wherein each of said connectors has a generally S-shape.

5. The device of claim 2, wherein each of said connectors is sized and shaped so as to expand and contract in a substantially radial direction.

6. The device of claim 5, wherein said inner ring is positioned substantially concentric relative to said outer ring.

7. The device of claim 2, wherein each of said connectors has an outer end, which is connected to said outer ring, an inner end, which is connected to said inner ring, and a connecting member, which extends between a corresponding one of said outer ends of said connectors and a corresponding one of said inner ends of said connectors.

8. The device of claim 7, wherein said connectors are spaced from each other so as to form an opening between each adjacent pair of said connectors for delivering fluid to the inner and outer filter members through said openings.

9. The device of claim 8, wherein said outer ring has a portion connected to an end of the outer filter member, and said inner ring has a portion connected to an end of the inner filter member.

10. The device of claim 9, wherein said inner ring includes an external wall, an internal wall, which is substantially concentric relative to said external wall, and a hole, which is defined by said internal wall.

11. The device of claim 1, wherein said connectors are spaced from each other so as to form an opening between each adjacent pair of said connectors for delivering fluid to the inner and outer filter members through said openings, each of said connectors being sized and shaped so as to induce a turbulent fluid flow to the inner and outer filter members.

12. The device of claim 1, wherein said connectors are formed integrally with said inner and outer rings as a single unit.

13. A filter assembly for use in filtering a fluid stream, comprising an outer filter member; an inner filter member; and a cap having an outer ring, which is connected to said outer filter member, an inner ring, which is connected to said inner filter member, and a plurality of connectors connecting said outer ring to said inner ring, said inner ring being positioned substantially within said outer ring, each of said connectors being sized and shaped so as to allow said outer ring and said inner ring to move relative to each other.

14. The filter assembly of claim 13, wherein each of said connectors is flexible so as to facilitate movement of said outer ring relative to said inner ring.

15. The filter assembly of claim 14, wherein each of said connectors is slanted with respect to an associated radial axis of said outer ring.

16. The filter assembly of claim 13, wherein each of said connectors has a generally S-shape.

17. The filter assembly of claim 14, wherein each of said connectors is sized and shaped so as to expand and contract in a substantially radial direction.

18. The filter assembly of claim 17, wherein said inner ring is substantially concentric relative to said outer ring.

19. The filter assembly of claim 14, wherein each of said connectors has an outer end, which is connected to said outer ring, an inner end, which is connected to said inner ring, and a connecting member, which extends between a corresponding one of said outer ends of said connectors and a corresponding one of said inner ends of said connectors.

20. The filter assembly of claim 19, wherein said connectors are spaced from each other so as to form an opening between each adjacent pair of said connecting members, said inner filter member being mounted within said outer filter member so as to form a space between said inner and outer filter members, each of said openings being in communication with said space for delivering fluid to said space through said openings.

21. The filter assembly of claim 20, wherein said outer ring has a wall connected to an end of said outer filter member, and said inner ring has an external wall connected to an end of said inner filter member.

22. The filter assembly of claim 21, wherein said inner ring includes an internal wall, which is substantially concentric relative to said external wall of said inner ring, and a hole, which is defined by said internal wall.

23. The filter assembly of claim 13, wherein said connectors are spaced from each other so as to form an opening between each adjacent pair of said connectors for delivering fluid to said inner and outer filter members through said openings, each of said connectors being sized and shaped so as to induce a turbulent fluid flow to said inner and outer filter members.

24. The filter assembly of claim 13, wherein said connectors are formed integrally with said inner and outer rings as a single unit.

25. The filter assembly of claim 13, further comprising a basket sized and shaped so as to receive and support said outer filter member and said inner filter member.

26. The filter assembly of claim 25, further comprising a filter vessel sized and shaped so as to receive said basket, said outer filter member, and said inner filter member.

27. The filter assembly of claim 26, further comprising sealing means for providing a seal between said outer ring and said filter vessel.

28. The filter assembly of claim 27, wherein said sealing means includes a sealing collar mounted to said outer ring and sized and shaped to engage said filter vessel in a fluid-tight manner.

29. The filter assembly of claim 25, wherein said basket includes an outer member and an inner member being mounted within said outer member so as to form a space between said inner and outer members of said basket, said space of said basket being sized and shaped so as to receive said outer filter member and said inner filter member.

30. The filter assembly of claim 29, wherein said outer ring is movable relative to said inner ring so as to facilitate proper positioning of said inner and outer filter members in said basket.
